(19) United States
(12) Patent Application Publication
(10) Pub. No.: US 2022/0135373 A1
(43) Pub. Date: May 5, 2022

(54) BRAKE SYSTEM FOR AN ELEVATOR CAR AND ELEVATOR SYSTEM

(71) Applicant: KONE Corporation, Helsinki (FI)

(72) Inventors: Juha-Matti AITAMURTO, Helsinki (FI); Ari KATTAINEN, Helsinki (FI)

(73) Assignee: KONE Corporation, Helsinki (FI)

(21) Appl. No.: 17/468,150

(22) Filed: Sep. 7, 2021

(30) Foreign Application Priority Data
Nov. 4, 2020 (EP) 20205701.4

(51) Int. Cl. B66B 5/16; B66B 1/36; B66B 11/04

(52) U.S. Cl. CPC B66B 5/16; B66B 9/003; B66B 11/0407; B66B 1/36

(57) ABSTRACT

A brake system for an elevator car, the brake system comprising a plurality of elevator car brakes, a plurality of electrical control units, and a plurality of electrical power supplies. Furthermore, at least two of the elevator car brakes are arranged to be operated by at least two of the electrical control units, and each one of the electrical control units is arranged to be supplied by at least one of the electrical power supplies. The brake system is configured so that at least two of the plurality of elevator car brakes are operable in case of a fault in any one or simultaneously in any two of the electrical control units and the electrical power supplies.

### FIELD OF THE INVENTION

The present invention relates in general to elevator systems. In particular, however not exclusively, the present invention concerns brake systems for elevator cars which are arranged to be moved by a linear motor.

### BACKGROUND

In known elevators, deceleration rate of an elevator car is controlled by controlling rope traction and electro-mechanical braking force. It is, however, also desirable to control the deceleration of the elevator car in various operating conditions in elevators utilizing linear motors. For example, when the elevator car is moving upwards and the motor fails, the brake is being applied and the deceleration becomes high which will be uncomfortable, if not dangerous, for the passengers inside the car. There is thus a need to develop the brake systems of elevators utilizing linear motors.

### SUMMARY

An objective of the present invention is to provide a brake system for an elevator car and an elevator system. Another objective of the present invention is that the brake system and the elevator system provide a way to control deceleration and/or acceleration of the elevator car reliably in various operating conditions, including some fault conditions.

The objectives of the invention are reached by a brake system for an elevator car and an elevator system as defined by the respective independent claims.

According to a first aspect, a brake system for an elevator car is provided. The brake system comprises a plurality of elevator car brakes, a plurality of electrical control units, and a plurality of electrical power supplies. At least two of the elevator car brakes are arranged to be operated by at least two of the electrical control units, and each one of the electrical control units is arranged to be supplied by at least one of the electrical power supplies. Furthermore, the brake system is configured so that at least two of the plurality of car brakes are operable in case of a fault occurring in any one or simultaneously in any two of the electrical control units and the electrical power supplies.

The plurality of elevator car brakes as referred to herein function so that they are switched from the non-braking position into the braking position when the electrical power injected to the brake is being interrupted. Thus, the brakes are kept in the non-braking position by supplying thereinto electrical power. In other words, the brakes are closed, that is switched into the braking position, if the electrical power is cut off, for example, due to a fault in the control/supply system thereof.

Furthermore, the number of the plurality of electrical control units and/or the number of plurality of electrical power supplies may be equal to or one more than the number of the plurality of elevator car brakes. The number of electrical power supplies may be one less than the number of the electrical control units.

In some embodiments, the number of the plurality of elevator car brakes is at least three or four.

Alternatively, a number of the plurality of car brakes may be two and the number of electrical control units may be four.

In various embodiments, alternatively or in addition, a number of electrical power supplies may be at least three or four.

Alternatively or in addition, each one of the electrical power supplies may be arranged to supply only one of the electrical control units.

In various embodiments, the at least two electrical control units, which are arranged to operate one of the car brakes, may be arranged in parallel with respect to each other to operate said one of the car brakes.

Alternatively or in addition, each one of the plurality of elevator car brakes may be adapted to be arranged in connection to one of a plurality of motor units of the elevator car. Furthermore, the elevator car brakes may be adapted to be arranged at ends of the motor units, respectively.

The type of the car brakes may be, for example, a holding brake, a machinery brake, or a brake for providing safety gear functions.

According to a second aspect, an elevator system is provided. The elevator system comprises at least one elevator car movable in an elevator shaft by a plurality of motor units, and at least one brake system in accordance with the first aspect.

Furthermore, the number of the plurality of motor units may, in some embodiments, be at least four, such as four.

In various embodiments, the electrical control units of the brake system are preferably further arranged to operate the motor units.

Alternatively or in addition, the electrical power supplies of the brake system may be further arranged to supply the motor units.

In various embodiments, the motor units may be movers of a linear motor. Furthermore, the linear motor may comprise at least two stator beams, wherein each one of the stator beams is arranged to co-act with at least one of the movers.

Still further, the elevator system may comprise a plurality of elevator cars movable in the elevator shaft. Said each one of the elevator cars may comprise the plurality of motor units, and the elevator system comprises a plurality of brake systems in accordance with the first aspect.

The present invention provides a brake system and an elevator system. The present invention provides advantages over known solutions in that the deceleration and/or acceleration rate can be kept low enough even in case of one or two faults in the components of the brake system operating and/or supplying the elevator car brakes.

Various other advantages will become clear to a skilled person based on the following detailed description.

The terms “first”, “second”, etc. are herein used to distinguish one element from another element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically an elevator system according to an embodiment of the present invention.

FIG. 2 illustrates schematically a motor unit according to an embodiment of the present invention.

FIG. 3 illustrates schematically a brake system according to an embodiment of the present invention.

FIG. 4 illustrates schematically a brake system according to an embodiment of the present invention.

FIG. 5 illustrates schematically a brake system according to an embodiment of the present invention.

FIG. 6 illustrates schematically a brake system according to an embodiment of the present invention.

### DETAILED DESCRIPTION OF SOME EMBODIMENTS

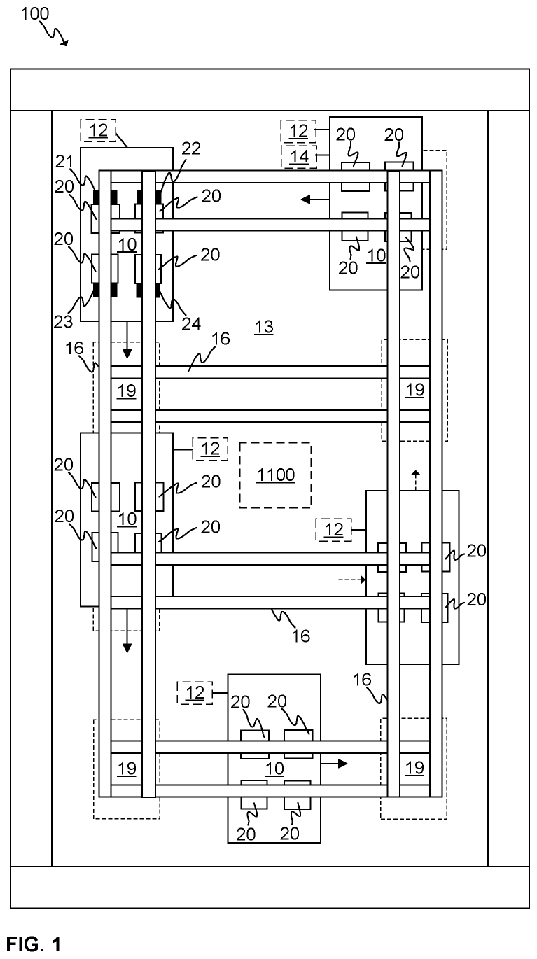

FIG. 1 illustrates schematically an elevator system 100 according to an embodiment of the present invention. The elevator system 100 may comprise at least one or a plurality of elevator cars 10 moving in the elevator shaft 13 or the elevator car pathway 13. The elevator car(s) 10 may comprise an electrical converter unit 12, such as comprising a frequency converter or an inverter, and, preferably, an energy storage 14, such as a battery or batteries, which are shown with dashed lines indicating the optionality of the feature. The electrical converter unit 12 may be utilized for operating a motor unit 20, such as comprising a mover of the linear motor, arranged to the elevator car 10 for moving the car 10 in the elevator shaft 13. There may also be other electrically operated equipment in the elevator car 10 such as lighting, doors, user interface, emergency rescue equipment, etc. The electrical converter unit 12 or an electrical power supply may be utilized for operating one or several of said other equipment of the elevator car 10. The energy storage 14 may, preferably, be electrically coupled to the electrical converter unit 12, for example, to the intermediate circuit of the frequency converter thereof, for providing electrical power to the electrical converter unit 12 and/or for storing electrical energy provided by the energy storage 14 or an electrical power supply.

There are preferably at least two landing floors 19 or landings 19, having landing floor doors or opening, comprised in the elevator system 100. There may also be doors comprised in the elevator car 10. Although shown in FIG. 1 that there are two horizontally separated sets, or “columns”, of landings 19, there could as well be only one column as in conventional elevators or more than two, for example, three.

Regarding the elevator shaft 13, it may be such as defining substantially closed volume in which the elevator car 10 is adapted and configured to be moved. The walls may be, for example, of concrete, metal or at least partly of glass, or any combination thereof. The elevator shaft 13 herein refers basically to any structure or pathway along which the elevator car 10 is configured to be moved.

As can be seen in FIG. 1, the elevator car 10 or cars 10 may be moved along the elevator shaft 13 vertically, in an inclined direction, and/or horizontally depending on the direction of stator beams 16. According to embodiments similar in this respect to the one in FIG. 1, the elevator car 10 or cars 10 may be configured to be moved along a number of vertical stator beams and/or horizontal and/or inclined stator beams, for example, two beams 16 such as shown in FIG. 1. The stator beams 16 may be part of a linear motor of the elevator 100 utilized to move the elevator car 10 or cars 10 in the elevator shaft 13. The stator beams 16 may, preferably, be arranged in fixed manner, that is, stationary with respect to the elevator shaft 13, for example, to a wall of the shaft by fastening portions, which may be arranged to rotatable at direction changing positions of the elevator car 10.

In preferable embodiments, the elevator system 100 may comprise two stator beams 16 in the shaft or hoistway 13, and the car(s) 10 may comprise four motor units 20, or movers, traveling along the two stator beams 16, for example, two motor units 20 per each stator beam 16, as shown in FIG. 1.

Furthermore, the elevator system 100 may comprise at least two brakes 21-24, for example, any two or more of car brakes 21-24 as shown in FIG. 1, for providing braking or deceleration, the brakes 21-24 being in each of the cars 10. There may alternatively be three or, preferably, four car brakes 21-24 in the car 10 or cars 10. The car brakes may, preferably, be arranged so that there is one brake 21-24 at the end of each motor unit 20.

The type of the car brakes 21-24 may be, for example, a holding brake, a machinery brake, or a brake for providing safety gear functions.

Furthermore, the elevator system 100 according to an embodiment of the present invention may comprise an elevator control unit 1100. External units may be connected to a communication interface of the elevator control unit. External unit may comprise wireless connection or a connection by a wired manner. The communication interface provides interface for communication with external units such as the elevator car 10, the motor units 20, the car brakes, the doors of the landing floors 19, or the electrical converter unit 12. There may also be connecting to the external system, such as a laptop or a handheld device. There may also be a connection to a database of the elevator system 100 or an external database including information used in controlling the operation of the elevator system 100.

The elevator control unit 1100 may comprise one or more processors, one or more memories being volatile or non-volatile for storing portions of computer program code and any data values and possibly one or more user interface units. The mentioned elements may be communicatively coupled to each other with e.g. an internal bus.

The processor of the elevator control unit 1100 is at least configured to implement at least some tasks associated with the operation of the elevator system 100, and specifically the brake system thereof. The implementation of the tasks may be achieved by arranging the processor to execute at least some portion of computer program code stored in the memory causing the processor, and thus the elevator control unit 1100, to implement said tasks. The processor is thus arranged to access the memory and retrieve and store any information therefrom and thereto. For sake of clarity, the processor herein refers to any unit suitable for processing information and control the operation of the elevator system 100, among other tasks. The operations may also be implemented with a microcontroller solution with embedded software. Similarly, the memory is not limited to a certain type of memory only, but any memory type suitable for storing the described pieces of information may be applied in the context of the present invention.

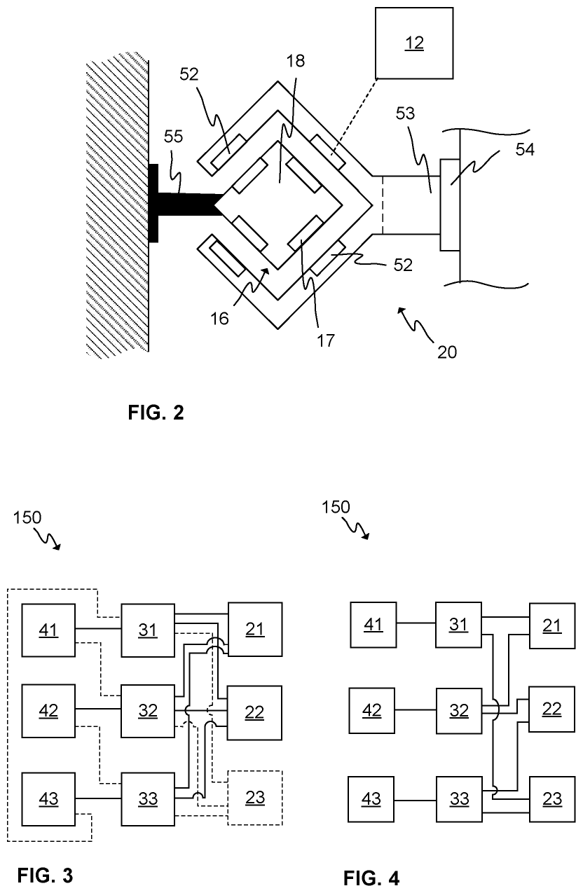

Still further, the elevator system 100 in accordance with various embodiments may comprise one or several brake systems (FIG. 1 only shows one non-limiting example of the elevator car brakes 21-24 of the brake system) as will be described hereinbelow with respect to FIGS. 3-6.

FIG. 2 illustrates schematically a motor unit 20, or at least a part thereof, according to an embodiment of the present invention. The motor unit 20 is, preferably, part of the linear motor, that is, including the mover thereof. In FIG. 2, the motor unit 20 is illustrated as a sectional view in directions perpendicular relative to the longitudinal direction of the stator beam 16.

The motor unit 20 may comprise, according to a non-limiting embodiment, a C-shaped or U-shaped (not shown) mover. The mover may comprise at least one or several permanent magnets and/or magnetic core element(s) or ferromagnetic material, and optionally, a unit or units of electromagnetic components 52 comprising at least one coil or winding. The unit or units of electromagnetic components 52 may, preferably, be comprised in the mover and adapted to face the stator 17 or stators 17 of the stator beam 16, as shown in FIG. 2, for instance. The stator beam 16 may, preferably, comprise the stators 17, and a core part 18, such as of magnetic or non-magnetic material. In some embodiments, the core part 18 may comprise non-metal, preferably also non-magnetic, material. These materials may include, for example, however, not limited to, polymers, or polymer composites.

Alternatively, the motor unit 20 may comprise, in the mover thereof, only one or several permanent magnets and/or magnetic core element(s) or ferromagnetic material, while the unit or units of electromagnetic components 52 reside in the stator beam 16. The unit or units of electromagnetic components 52 may be part of the stator 17 thus enabling forming of the controllable magnetic field for moving the mover in electromagnetic engagement with the stator 17. The units of electromagnetic components 52, when comprised in the mover, may be arranged to be in electromagnetic engagement with the stators 17 for moving the mover along the stator beam 16. There may also be a support portion 53 by which mover may be attached or coupled to the elevator car 10, for example, to the back wall of the car 10. As can be seen, the mover may be shaped and designed in such a way as to enable the movement of the mover along the stator beam 16 without interference from the fastening or support portions 55, 53. There may, furthermore, be further support portions 54 utilized to attach the mover to the elevator car 10. The further support portion 54 may be rotatable, for instance.

The movement of the motor unit 20 along the stator beam 16 may be implemented by known control methods, such as, field-oriented or vector control or the like. The basic idea is to produce an alternating magnetic field, for example by the electrical converter unit(s) 12, by injecting current to a unit of electromagnetic components 52 of the mover, such as to a winding or coil thereof. The unit of electromagnetic components 52 facing the stator 17 then co-acts with the stator 17 through the electromagnetic engagement and produces a force which moves the motor unit 20, and thus the elevator car 10 along the stator beam 16.

FIG. 3 illustrates schematically a brake system 150, or at least a portion thereof, according to an embodiment of the present invention. As can be seen, the brake system 150 may comprise a plurality of elevator car brakes 21-23, such as two, or optionally three (optional one of the car brakes 23 being marked with a dashed line), in this case. Each one, that is, at least two, of the elevator car brakes 21-23 may be arranged to be operated by at least two, or three, electrical control units 31-33. The total number of electrical control units 31-33 is three in the case of FIG. 3. Furthermore, each one of the electrical control units 31-33 may be arranged to be supplied by at least one electrical power supply 41-43. Thus, the total number of electrical power supplies 41-43 is three in the case of FIG. 3. As can be seen, the electrical power supplies 41-43 may be arranged to supply one or more of the electrical control units 31-33.

The brake system 150 of FIG. 3 may be configured so that at least two of the plurality of elevator car brakes 21-23 are operable in case of a fault in any one or simultaneously in any two of the electrical control units 31-33 and the electrical power supplies 41-43.

For example, a fault in any one of the electrical control units 31-33 (e.g. in 31) would result in a situation where each one of the car brakes 21-22 (or 21-23) is operated still by two electrical control units 31-33 (e.g. units 32 and 33). In another example, simultaneous faults in any two of the electrical control units 31-33 (e.g. in 31 and 32) would result in a situation where each one of the car brakes 21-22 (or 21-23) is operated still by one electrical control unit 31-33 (e.g. unit 33).

On the other hand, a fault in any one of the electrical power supplies 41-43 (e.g. in 41) would result in a situation where two electrical control units 31-33 (e.g. 32 and 33) are supplied by two electrical power supplies 41-43 (e.g. 42 and 43), respectively, and, thus, two of the car brakes 21-22 (or three, that is, 21-23) would remain operable. Still further, as another example, simultaneous faults in any two of the electrical power supplies 41-43 (e.g. supplies 42 and 43) would result in a situation where each one of the car brakes 21-22 (or 21-23) is operated still by one of the electrical control units 31-33 (e.g. unit 31).

FIG. 4 illustrates schematically a brake system 150, or at least a portion thereof, according to an embodiment of the present invention. As can be seen, the brake system 150 may comprise at least three elevator car brakes 21-23. Each one of the elevator car brakes 21-23 may be arranged to be operated by at least two electrical control units 31-33. The total number of electrical control units 31-33 is three in this case, that is, equal to the number of car brakes 21-23. Furthermore, each one of the electrical control units 31-33 may be arranged to be supplied by at least one electrical power supply 41-43. The total number of electrical power supplies 41-43 is three in the case of FIG. 4. Thus, the number of electrical control units 31-33 is equal to the number of elevator car brakes 21-23 and to the number of electrical power supplies 41-43.

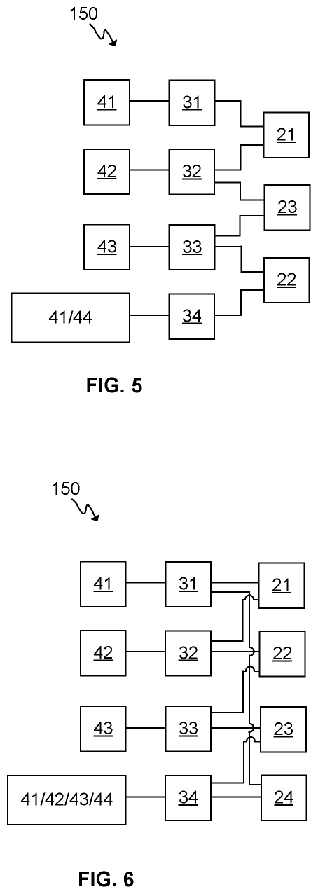

FIG. 5 illustrates schematically a brake system 150, or at least a portion thereof, according to an embodiment of the present invention. As can be seen, the brake system 150 may comprise at least three elevator car brakes 21-23. Each one of the elevator car brakes 21-23 may be arranged to be operated by at least two electrical control units 31-34. The total number of electrical control units 31-34 is four in this case, that is, one more than the number of car brakes 21-23. Furthermore, each one of the electrical control units 31-34 may be arranged to be supplied by at least one electrical power supply 41-44. The total number of electrical power supplies 41-44 is three or four in the case of FIG. 5. Thus, the number of electrical control units 31-34 is higher by one relative to the number of elevator car brakes 21-23 and may be one higher or equal to the number of electrical power supplies 41-44.

In FIG. 5, each one of the at least four electrical control units 31-34 is arranged to operate at least one of the car brakes 21-23. However, two of the at least four electrical control units 31-34, that is 32 and 33, are arranged to operate further one of the three car brakes 21-23 in addition to said at least one of the car brakes 21-23. Thereby, the brake system 150 of FIG. 5 is configured so that at least two of the plurality of elevator car brakes 21-23 are operable in case of a fault in any one or simultaneously in any two of the electrical control units 31-34 and the electrical power supplies 41-43 or 41-44.

FIG. 6 illustrates schematically a brake system 150, or at least a portion thereof, according to an embodiment of the present invention. As can be seen, the brake system 150 may comprise at least four elevator car brakes 21-24. Each one of the elevator car brakes 21-24 may be arranged to be operated by two of the four electrical control units 31-34. Furthermore, each one of the electrical control units 31-34 may be arranged to be supplied by at least one electrical power supply 41-44. The total number of electrical power supplies 41-44 is four in this case too. In FIG. 6, each one of the electrical control units 31-34 is arranged to operate (at least) two of the car brakes 21-24. Thereby, the brake system 150 of FIG. 6 is configured so that at least two of the plurality of elevator car brakes 21-24 are operable in case of a fault in any one or simultaneously in any two of the electrical control units 31-34 and the electrical power supplies 41-44.

1. A brake system for an elevator car, comprising a plurality of elevator car brakes, a plurality of electrical control units, and a plurality of electrical power supplies; wherein at least two of the elevator car brakes are arranged to be operated by at least two of the electrical control units;
each one of the electrical control units is arranged to be supplied by at least one of the electrical power supplies; and
the brake system is configured so that at least two of the plurality of elevator car brakes are operable in case of a fault in any one or simultaneously in any two of the electrical control units and the electrical power supplies.

2. The brake system of claim 1, wherein the number of the plurality of electrical control units and/or the number of plurality of electrical power supplies is equal to or one more than the number of the plurality of elevator car brakes.

3. The brake system of claim 1, wherein the number of electrical power supplies is one less than the number of the electrical control units.

4. The brake system of claim 1, wherein the number of the plurality of elevator car brakes is at least three or four.

5. The brake system of claim 1, wherein each one of the electrical power supplies is arranged to supply only one of the electrical control units.

6. The brake system of claim 1, wherein the at least two of the electrical control units, which are arranged to operate one of the elevator car brakes, are arranged in parallel with respect to each other to operate said one of the elevator car brakes.

7. The brake system of claim 1, wherein each one of the plurality of elevator car brakes is adapted to be arranged in connection to one of a plurality of motor units of the elevator car.

8. The brake system of claim 7, wherein the elevator car brakes are adapted to be arranged at ends of the motor units, respectively.

9. An elevator system comprising at least one elevator car movable in an elevator shaft by a plurality of motor units; wherein said elevator system comprises at least one brake system of claim 1.

10. The elevator system of claim 9, wherein a number of the plurality of motor units is at least four.

11. The elevator system of claim 9, wherein the electrical control units of the brake system are further arranged to operate the motor units.

12. The elevator system of claim 9, wherein the electrical power supplies of the brake system are further arranged to supply the motor units.

13. The elevator system of claim 9, wherein the motor units are movers of a linear motor.

14. The elevator system of claim 13, wherein the linear motor comprises at least two stator beams, wherein each one of the stator beams is arranged to co-act with at least one of the movers.

15. The elevator system of claim 9, comprising a plurality of elevator cars movable in the elevator shaft, wherein said each one of the elevator cars comprises the plurality of motor units, and the elevator system comprises a plurality of brake systems.

16. The brake system of claim 2, wherein the number of electrical power supplies is one less than the number of the electrical control units.

17. The brake system of claim 2, wherein the number of the plurality of elevator car brakes is at least three or four.

18. The brake system of claim 3, wherein the number of the plurality of elevator car brakes is at least three or four.

19. The brake system of claim 2, wherein each one of the electrical power supplies is arranged to supply only one of the electrical control units.

20. The brake system of claim 3, wherein each one of the electrical power supplies is arranged to supply only one of the electrical control units.
